(19) United States
(12) Patent Application Publication
(10) Pub. No.: US 2024/0248961 A1
(43) Pub. Date: Jul. 25, 2024

(54) LATER-FUSION MULTIPLE KERNEL CLUSTERING MACHINE LEARNING METHOD AND SYSTEM BASED ON PROXY GRAPH IMPROVEMENT

(71) Applicant: ZHEJIANG NORMAL UNIVERSITY, Jinhua (CN)

(72) Inventors: Xinzhong ZHU, Jinhua (CN); Huiying XU, Jinhua (CN); Miaomiao LI, Jinhua (CN); Weixuan LIANG, Jinhua (CN); Jianping YIN, Jinhua (CN); Jianmin ZHAO, Jinhua (CN)

(73) Assignee: ZHEJIANG NORMAL UNIVERSITY, Jinhua (CN)

(21) Appl. No.: 18/566,089

(22) PCT Filed: May 30, 2022
(86) PCT No.: PCT/CN2022/095836

§ 371 Date: Dec. 1, 2023

(30) Foreign Application Priority Data
Jun. 1, 2021 (CN) 202110607669.7

(51) Int. Cl. G06F 18/23213; G06F 17/16; G06N 20/00

(52) U.S. Cl. CPC G06F 18/23213; G06F 17/16; G06N 20/00

(57) ABSTRACT

A later-fusion multiple kernel clustering machine learning method and system based on proxy graph improvement is provided. The method includes: S1. acquiring a clustering task and a target data sample; S2. initializing a proxy graph improvement matrix; S3. running k-means clustering and graph improvement on each view corresponding to the acquisition of the clustering task and the target data sample, and constructing an objective function by combining kernel k-means clustering and graph improvement methods; S4. cyclically solving the objective function constructed in step S3 so as to obtain a graph matrix, which is fused with basic kernel information; and S5. performing spectral clustering on the obtained graph matrix, so as to obtain a final clustering result. By means of the method, an optimized basic division not only has information of a single kernel, but can also obtain global information by means of a proxy graph.

### TECHNICAL FIELD

The present disclosure relates to the technical field of machine learning, and in particular to a later-fusion multiple kernel clustering machine learning method and system based on proxy graph improvement.

### BACKGROUND

Aiming at dividing unlabeled data into several unrelated classes, clustering plays an important role in machine learning and data analysis. In the era of big data, data may come from multiple sources, known as multi-view data. Methods for clustering multi-view data are called multi-view clustering algorithms. Multi-kernel clustering algorithms are an important branch of multi-view clustering, with the aim of making full use of a series of predefined basis kernels to improve clustering performance.

Existing multi-kernel clustering algorithms can be roughly divided into two categories, i.e. early fusion and later fusion, according to the timing of fusion. Early fusion refers to a fusion of several kernel matrices before performing a kernel k-means algorithm. Specifically, a method of regularization term induced by matrix (X. Liu, Y Dou, J. Yin, et al., Multiple Kernel K-means Clustering with Matrix-induced Regularization in AAAI 2016, pp. 1888-1894) can be used to adaptively adjust a kernel coefficient according to the similarity of kernel matrices, such that the redundancy of similar information is avoided, and the quality of the optimal kernel matrix is accordingly improved. A method for maintaining the local structure of a kernel (M. Gonen and A. A. Margolin, Localized Data Fusion for Kernel K-means Clustering with Application to Cancer Biology in Neur IPS 2014, pp. 1305-1313) can also improve the effects of algorithms.

For later fusion of multi-kernel clustering first, the kernel k-means algorithm is first performed for basis kernel matrices to obtain basic divisions, and then these basic divisions are fused. A later fusion algorithm based on maximum alignment (S. Wang, X. Liu, E. Zhu, et al., Multi-view Clustering via Late Fusion Alignment Maximization in IJCAI 2019, pp. 3778-3784) makes use of permutation matrices to achieve an alignment effect of the basic divisions, and then combines the basic divisions. A later fusion method proposed by Liu et al. (X. Liu, M. Li, C. Tang, et al., Efficient and Effective Regularized Incomplete Multi-view Clustering in T-PAMI 2020) is capable of handling incomplete view data and obtaining a good clustering effect.

Compared with the early fusion, the later fusion features very low computational and storage complexities, and relatively desirable clustering performance. However, existing later fusion clustering algorithms still have the following deficiencies: first, a clustering process of the basis kernel is separated from a later fusion process of the basic divisions, in which case, the quality of the basic divisions has a great impact on the performance of the final clustering, and outliers and noises therein, if any, will result in an unsatisfactory clustering effect. Second, existing methods simply take a consistency division as a linear transformation of the basic divisions, making it difficult to be applied to the field of multi-kernel data in reality.

### SUMMARY

In order to overcome deficiencies in the prior art, the present disclosure provides a later-fusion multiple kernel clustering machine learning method and system based on proxy graph improvement.

In order to achieve the above objective, the present disclosure adopts the following technical solution:
a later-fusion multiple kernel clustering machine learning method and system based on proxy graph improvement, including the following steps:
S1. acquiring a clustering task and a target data sample;
S2. initializing a proxy graph improvement matrix;
S3. running k-means clustering and graph improvement on each view corresponding to the acquisition of the clustering task and the target data sample, and constructing an objective function by combining kernel k-means clustering and graph improvement methods;
S4. cyclically solving the objective function constructed in the step S3 so as to obtain a graph matrix, which is fused with basic kernel information; and
S5. performing spectral clustering on the obtained graph matrix, so as to obtain a final clustering result.

Further, the objective function of kernel k-means clustering constructed in the step S3 is expressed as:

$$\\ \begin{matrix}{min}_{B ∈ {\{ 0 , 1 \}}^{n \times k}} {\sum }_{i = 1 , c = 1}^{n , k} {B}_{ic} {‖ ϕ ( {x}_{i} ) - {μ}_{c} ‖}_{2}^{2} s . t . {\sum }_{c = 1}^{k} {B}_{ic} = 1 & ( 1 )\end{matrix}$$

where {xᵢ}ᵢ₌₁ⁿ⊆ [symbol] represents a data set consisting of n samples; B∈{0,1}^{n×k} represents a clustering indicator matrix, when an i^{th} sample belongs to a c^{th} cluster, B_{ic}=1, otherwise, B_{ic}=0; ϕ:x∈ [symbol] → [symbol] represent feature mapping that a sample x is projected to a reproducing kernel Hilbert space [symbol] ; μ_{c}=(1/n_{c})Σᵢ₌₁ⁿB_{ic}ϕ(xᵢ), where n_{c} represents the number of samples belonging to the c^{th} cluster, xᵢ represents a data sample; i represents a sample serial number; n represents the number of sample points; and k represents a total number of clusters.

Assuming <ϕ(xᵢ),ϕ(xⱼ)>=Kᵢⱼ, where Kᵢⱼ represents elements of a kernel matrix K, then Equation (1) is expressed as:

$$\\ \begin{matrix}{min}_{B ∈ {\{ 0 , 1 \}}^{n \times k}} Tr ( K ) - Tr ( {L}^{\frac{1}{2}} {B}^{{}_{} T} {KBL}^{\frac{1}{2}} ) s . t . B {1}_{k} = {1}_{n} & ( 2 )\end{matrix}$$

where K represents the kernel matrix, L=diag([n₁⁻¹, . . . , nₖ⁻¹]), nₖ⁻¹ represents a reciprocal of a total number of samples belonging to a k^{th} cluster, 1ₖ∈R^{k} represents a vector with all elements being 1; and B^{T} represents a transpose of B.

Assuming

$$H = {BL}^{\frac{1}{2}} and {H}^{T} H = {I}_{k} ,$$

then Equation (2) is expressed as:

$${min}_{{H}^{T} H = {I}_{k}} Tr ( K ( {I}_{n} - {HH}^{T} ) ) \qquad ( 3 )$$

where H^{T} represents a transpose of H, Iₙ represents an n-dimensional identity matrix, and Iₖ represents a k-dimensional identity matrix.

Further, the objective function constructed in the step S3 is expressed as:

$${min}_{S , {\{ {H}_{i} \}}_{i = 1}^{m}} {\sum }_{i = 1}^{m} Tr ( {K}_{i} ( {I}_{n} - {H}_{i} {H}_{i}^{T} ) ) + λ {‖ {H}_{i} - {SH}_{i} ‖}_{F}^{2} + β {‖ S ‖}_{F}^{2} \qquad ( 4 )$$

$$s . t . S \geq 0 , S 1 = 1 , diag ( S ) = 0 , {H}_{i}^{T} {H}_{i} = {I}_{k} \qquad ( 5 )$$

where Hᵢ represents a basic division matrix obtained from an i^{th} running kernel k-means clustering; λ and β represent hyperparameters that adjust a proportion of each item; Hᵢ^{T} represents a transpose of Hᵢ; S represents a proxy graph matrix; and Iₙ represents the n-dimensional identity matrix.

Further, the objective function constructed in the step S3 is cyclically solved in the step S4, specifically:

S41. fixing S and optimizing {Hᵢ}ᵢ₌₁^{m}, being expressed as:

$${min}_{{H}_{i}} Tr ( {K}_{i} ( {I}_{n} - {H}_{i} {H}_{i}^{T} ) ) + λ {‖ {H}_{i} - {SH}_{i} ‖}_{F}^{2} , s . t . {H}_{i}^{T} {H}_{i} = {I}_{k} \qquad ( 6 )$$

assuming G=Kᵢ−λ(Iₙ−2S+SS^{T}), then Equation (6) is expressed as:

$$Tr ( {GH}_{i} {H}_{i}^{T} ) , s . t . {H}_{i}^{T} {H}_{i} = {I}_{k} \qquad ( 7 )$$

performing eigendecomposition on G, assuming that Hᵢ represents an eigenvector corresponding to its first k largest eigenvalues, and then obtaining the optimal solution;
S42. fixing {Hᵢ}ᵢ₌₁^{m} and optimizing S, being expressed as:

$${min}_{s} {\sum }_{i = 1}^{m} λ {‖ {H}_{i} - {SH}_{i} ‖}_{F}^{2} + β {‖ S ‖}_{F}^{2} , s . t . S \geq 0 , S 1 = 1 , diag ( S ) = 0 \qquad ( 8 )$$

Equation (8) is solved through the steps S421 and S422:
S421. solving an unconstrained solution of Equation (8), being expressed as:

$$\hat{S} = {argmin}_{S} {\sum }_{i = 1}^{m} λ {‖ {H}_{i} - {SH}_{i} ‖}_{F}^{2} + β {‖ S ‖}_{F}^{2} \qquad ( 9 )$$

Using a derivative 0 to obtain a closed-form solution

$$\hat{S} = {( C + ( \frac{β}{λ} ) I )}^{- 1} C , where C = {\sum }_{i = 1}^{m} {H}_{i} {H}_{i}^{T} ;$$

S422. calculating a solution closest to Ŝ that satisfies constraints through Equation (10):

$${min}_{S} {‖ S - \hat{S} ‖}_{F}^{2} , s . t . S \geq 0 , S 1 = 1 , diag ( S ) = 0 \qquad ( 10 )$$

where Ŝ represents a solution of the proxy graph matrix when being unconstrained.

Obtaining a closed-form solution:

$${S}_{j , :} = max ( {\hat{S}}_{j , :} + {α}_{j} 1 , 0 ) , {S}_{jj} = 0 , {α}_{j} = \frac{1 + {\hat{S}}_{j , :}^{T} 1}{n} \qquad ( 11 )$$

where S_{j,:} represents a j^{th} column of a matrix S, αⱼ represents an intermediate variable used for solution; Ŝ_{j,:} represents a j^{th} column of Ŝ; and Ŝ_{j,:}^{T} represents a transpose of Ŝ_{j,:}.

Further, the objective function constructed in the step S3 is cyclically solved, with a cycle termination condition being expressed as:

$$\frac{{obj}^{( t - 1 )} - {obj}^{( t )}}{{obj}^{( t )}} \leq ε \qquad ( 12 )$$

where obj^{(t-1)} and obj^{(t)} represent values of the objective function at t^{th} and t−1^{th} iterations, respectively; and E represents a set precision.

Correspondingly, the present disclosure further provides a later-fusion multiple kernel clustering machine learning system based on proxy graph improvement, including:
an acquisition module for acquiring a clustering task and a target data sample;
an initialization module for initializing a proxy graph improvement matrix;
a construction module for running k-means clustering and graph improvement on each view corresponding to the acquisition of the clustering task and the target data sample, and constructing an objective function by combining kernel k-means clustering and graph improvement methods;
a solution module for cyclically solving the constructed objective function, so as to obtain a graph matrix, which is fused with basic kernel information; and
a clustering module for performing spectral clustering on the obtained graph matrix, so as to obtain a final clustering result.

Further, the objective function of kernel k-means clustering in the construction module is expressed as:

$${min}_{B ∈ {\{ 0 , 1 \}}^{n \times k}} {\sum }_{i = 1 , c = 1}^{n , k} {B}_{i c} {‖ ϕ ( {x}_{i} ) - {μ}_{c} ‖}_{2}^{2} s . t . {\sum }_{c = 1}^{k} {B}_{ic} = 1 \qquad ( 1 )$$

where {xᵢ}ᵢ₌₁ⁿ⊆ [symbol] represents a data set consisting of n samples; B∈{0,1}^{n×k} represents a clustering indicator matrix, when an i^{th} sample belongs to a c^{th} cluster, B_{ic}=1, otherwise, B_{ic}=0; ϕ:x∈ [symbol] → [symbol] represents feature mapping that a sample x is projected to a reproducing kernel Hilbert space [symbol] ; μ_{c}=(1/n_{c})Σᵢ₌₁ⁿ=B_{ic}ϕ(xᵢ), where n_{c} represents the number of samples belonging to the c^{th} cluster, xᵢ represents a data sample; and i represents a sample serial number; n represents the number of sample points; and k represents a total number of clusters.

assuming <ϕ(xᵢ),ϕ(xⱼ)>=Kᵢⱼ, where Kᵢⱼ represents elements of a kernel matrix K, then Equation (1) is expressed as:

$${min}_{B ∈ {\{ 0 , 1 \}}^{n \times k}} Tr ( K ) - Tr ( {L}^{\frac{1}{2}} {B}^{T} {KBL}^{\frac{1}{2}} ) s . t . B {1}_{k} = {1}_{n} \qquad ( 2 )$$

where K represents the kernel matrix, L=diag([n₁⁻¹, . . . , nₖ⁻¹]), nₖ⁻¹ represents a reciprocal of a total number of samples belonging to a k^{th} cluster, 1ₖ∈R^{k} represents a vector with all elements being 1; and B^{T} represents a transpose of B.
assuming

$$H = {BL}^{\frac{1}{2}} {H}^{T} H = {I}_{k} ,$$

then Equation (2) is expressed as:

$${min}_{{H}^{T} H = {I}_{k}} Tr ( K ( {I}_{n} - {HH}^{T} ) ) \qquad ( 3 )$$

where H^{T} represents a transpose of H, Iₙ represents an n-dimensional identity matrix, and Iₖ represents a k-dimensional identity matrix.

Further, the objective function constructed in the construction module is expressed as:

$${min}_{S , {\{ {H}_{i} \}}_{i = 1}^{m}} {\sum }_{i = 1}^{m} T r ( {K}_{i} ( {I}_{n} - {H}_{i} {H}_{i}^{T} ) ) + λ {‖ {H}_{i} - S {H}_{i} ‖}_{F}^{2} + β {‖ S ‖}_{F}^{2} \qquad ( 4 )$$

$$s . t . S \geq 0 , S 1 = 1 , diag ( S ) = 0 , {H}_{i}^{T} {H}_{i} = {I}_{k} \qquad ( 5 )$$

where Hᵢ represents a basic division matrix obtained from an i^{th} running kernel k-means clustering; λ and β represent hyperparameters that adjust a proportion of each item; Hᵢ^{T} represents a transpose of Hᵢ; S represents a proxy graph matrix; and Iₙ represents the n-dimensional identity matrix.

Further, the constructed objective function is cyclically solved in the solution module, specifically:
a first fixed module is used for fixing S and optimizing {Hᵢ}ᵢ₌₁^{m}, being expressed as:

$${min}_{{H}_{i}} T r ( {K}_{i} ( {I}_{n} - {H}_{i} {H}_{i}^{T} ) ) + λ {‖ {H}_{i} - S {H}_{i} ‖}_{F}^{2} , s . t . {H}_{i}^{T} {H}_{i} = {I}_{k} \qquad ( 6 )$$

assuming G=Kᵢ−λ(I−2S+SS^{T}), then Equation (6) is expressed as:

$$T r ( G {H}_{i} {H}_{i}^{T} ) , s . t . {H}_{i}^{T} {H}_{i} = {I}_{k} \qquad ( 7 )$$

performing eigendecomposition on G, assuming that Hᵢ represents an eigenvector corresponding to its first k largest eigenvalues, and then obtaining the optimal solution;
a second fixed module is used for fixing {Hᵢ}ᵢ₌₁^{m} and optimizing S, being expressed as:

$${min}_{S} {\sum }_{i = 1}^{m} λ {‖ {H}_{i} - S {H}_{i} ‖}_{F}^{2} + β {‖ S ‖}_{F}^{2} , s . t . S \geq 0 , S 1 = 1 , diag ( S ) = 0 \qquad ( 8 )$$

Solving Equation (8):
solving an unconstrained solution of Equation (8), being expressed as:

$$\hat{S} = {arg min}_{S} {\sum }_{i = 1}^{m} λ {‖ {H}_{i} - S {H}_{i} ‖}_{F}^{2} + β {‖ S ‖}_{F}^{2} \qquad ( 9 )$$

using a derivative 0 to obtain a closed-form solution

$$\hat{S} = {( C + ( \frac{β}{λ} ) I )}^{- 1} C , where C = {Σ}_{i = 1}^{m} {H}_{i} {H}_{i}^{T} ;$$

calculating a solution closest to S that satisfies constraints:

$${min}_{S} {‖ S - \hat{S} ‖}_{F}^{2} , s . t . S \geq 0 , S 1 = 1 , diag ( s ) = 0 \qquad ( 10 )$$

where Ŝ represents a solution of the proxy graph matrix when being unconstrained.

Obtaining a closed-form solution:

$${S}_{j , :} = max ( {\hat{S}}_{j , :} + {α}_{i} 1 , 0 ) {S}_{jj} = 0 , {α}_{j} = \frac{1 + {\hat{S}}_{j , :}^{T} 1}{n} \qquad ( 11 )$$

where S_{j,:} represents a j^{th} column of a matrix S, αⱼ represents an intermediate variable used for solution; Ŝ_{j,:} represents a j^{th} column of Ŝ; and S_{j,:}^{T} represents a transpose of Ŝ_{j,:}.

Further, the constructed objective function is cyclically solved, with a cycle termination condition being expressed as:

$$\frac{o b {j}^{( t - 1 )} - o b {j}^{( t )}}{o b {j}^{( t )}} \leq ε \qquad ( 12 )$$

where obj^{(t-1)} and obj^{(t)} represent values of the objective function at t^{th} and t−1^{th} iterations, respectively; and E represents a set precision.

Compared with the prior art, the present disclosure provides a novel later-fusion multiple kernel clustering machine learning method based on proxy graph improvement, and the method includes a basic division acquisition module, a proxy graph construction module, a basic division improvement module through the proxy graph, a spectral clustering module through the proxy graph, and the like. By optimizing the basic division, an optimized basic division not only has information of a single kernel, but can also obtain global information by means of a proxy graph, which is more beneficial to fusing views, such that a learned proxy graph can better fuse information of each kernel matrix, thereby realizing an aim of improving a clustering effect. Results of experiments on six multi-kernel data sets prove that the performance of the present disclosure is better than those of existing methods.

### BRIEF DESCRIPTION OF THE DRAWINGS

FIG. 1 is a flowchart of a later-fusion multiple kernel clustering machine learning method based on proxy graph improvement provided in Embodiment 1 of the present disclosure.

FIG. 2 is a schematic diagram of a later-fusion multiple kernel clustering based on proxy graph improvement provided in Embodiment 1 of the present disclosure.

FIG. 3 is a schematic diagram of changes in values of objective function as the number of iterations increases provided in Embodiment 2 of the present disclosure.

FIG. 4 is a schematic diagram of parameter sensitivity provided in Embodiment 2 of the present disclosure.

### DETAILED DESCRIPTIONS OF THE EMBODIMENTS

The implementation of the present disclosure will be illustrated below in conjunction with specific embodiments. Those skilled in the art can easily understand other advantages and effects of the present disclosure from the content disclosed in the Specification. The present disclosure can also be implemented or applied through other different specific implementations, and various modifications or variations can be made to details in the specification based on different viewpoints and applications without departing from the spirit of the present disclosure. It should be noted that the embodiments below and features in the embodiments can be combined with each other, so long as they are not in conflict with each other.

In order to overcome defects of the prior art, the present disclosure provides a later-fusion multiple kernel clustering machine learning method and system based on proxy graph improvement.

### Embodiment 1

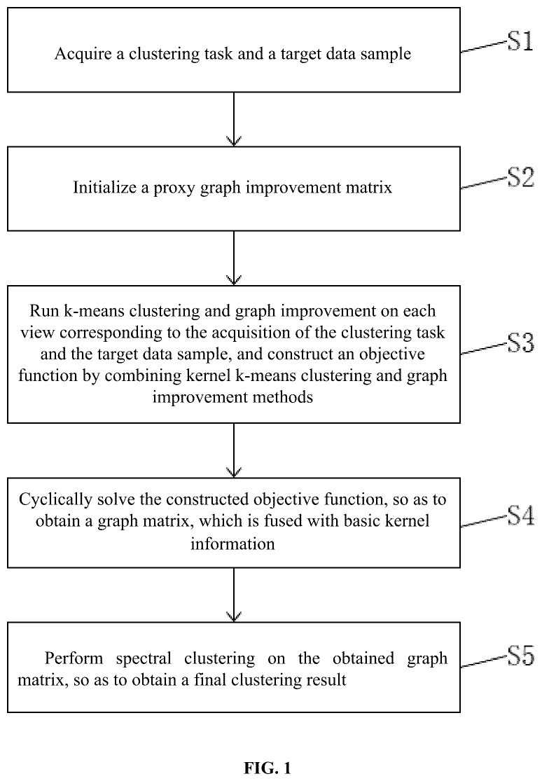

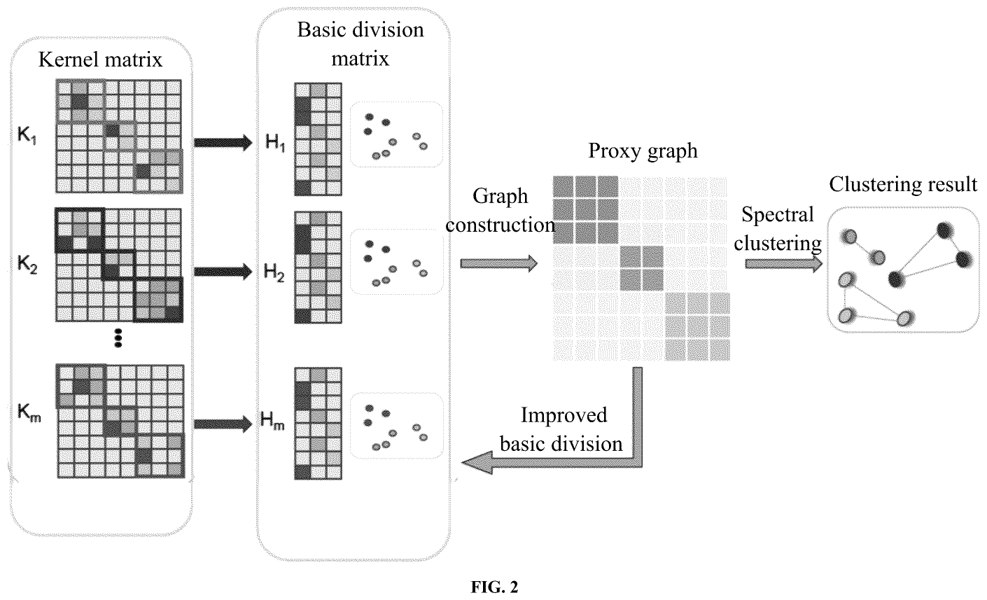

This embodiment provides a later-fusion multiple kernel clustering machine learning method based on proxy graph improvement, as shown in FIGS. 1-2, including the following steps:
S1. acquiring a clustering task and a target data sample;
S2. initializing a proxy graph improvement matrix;
S3. running k-means clustering and graph improvement on each view corresponding to the acquisition of the clustering task and the target data sample, and constructing an objective function by combining kernel k-means clustering and graph improvement methods;
S4. cyclically solving the objective function constructed in the step S3 so as to obtain a graph matrix, which is fused with basic kernel information; and
S5. performing spectral clustering on the obtained graph matrix, so as to obtain a final clustering result.

In the step S3, k-means clustering and graph improvement are run on each view corresponding to the acquisition of the clustering task and the target data sample, and an objective function is constructed by combining kernel k-means clustering and graph improvement methods.

A kernel k-means clustering objective function is expressed as follows: {xᵢ}ᵢ₌₁ⁿ⊆ [symbol] represents a data set consisting of n samples, assuming that a kernel function is κ(⋅, ⋅), and κ(x,x′)=<ϕ(x),ϕ(x′)> according to the nature of a reproducing kernel, where ϕ:x∈ [symbol] → [symbol] represents feature mapping that a sample x is projected to a reproducing kernel Hilbert space [symbol] . ϕ(x) is substituted into an objective function of k-means clustering to obtain an objective function of the kernel k-means clustering, which is expressed as:

$${min}_{B ∈ {\{ 0 , 1 \}}^{n \times k}} {\sum }_{i = 1 , c = 1}^{n , k} {B}_{i c} {‖ ϕ ( {x}_{i} ) - {μ}_{c} ‖}_{2}^{2} s . t . {\sum }_{c = 1}^{k} {B}_{i c} = 1 \qquad ( 1 )$$

where B∈{0,1}^{n×k} represents a clustering indicator matrix, when the i^{th} sample belongs to the c^{th} cluster, B_{ic}=1, otherwise, B_{ic}=0; μ_{c}=(1/n_{c})Σᵢ₌₁ⁿB_{ic}ϕ(xᵢ), where n_{c} represents the number of samples belonging to the c^{th} cluster, xᵢ represents a data sample; i represents a sample serial number; n represents the number of sample points; and k represents a total number of clusters.

The kernel trick is used, assuming <ϕ(xᵢ),ϕ(xⱼ)>=Kᵢⱼ, where Kᵢⱼ represents elements of a kernel matrix K, then Equation (1) is expressed as:

$${min}_{B ∈ {\{ 0 , 1 \}}^{n \times k}} T r ( K ) - T r ( {L}^{\frac{1}{2}} {B}^{T} K B {L}^{\frac{1}{2}} ) s . t . B {1}_{k} = {1}_{n} \qquad ( 2 )$$

where K represents the kernel matrix, L=diag([n₁⁻¹, . . . , nₖ⁻¹]), nₖ⁻¹ represents a reciprocal of a total number of samples belonging to a k^{th} cluster, 1ₖ∈R^{k} represents a vector with all elements being 1; and B^{T} represents a transpose of B.

An optimization about B in Equation (2) has been proved to be an NP-hardness problem, therefore, discrete constraints of B are transformed into real-valued orthogonal constraints, and assuming

$$H = B {L}^{\frac{1}{2}} and {H}^{T} H = {I}_{k} ,$$

Equation (2) is then expressed as:

$${min}_{{H}^{T} H = {I}_{k}} T r ( K ( {I}_{n} - H {H}^{T} ) ) \qquad ( 3 )$$

where H^{T} represents a transpose of H, Iₙ represents an n-dimensional identity matrix, and Iₖ represents a k-dimensional identity matrix.

In this embodiment, eigendecomposition can be performed on the kernel matrix K, and the optimal H is an eigenvector corresponding to the first k largest eigenvalues of the K.

The function improvement of the graph improvement part is specifically as follows: assuming that the basic division obtained by an i^{th} running kernel k-means clustering is Hᵢ, in order to obtain the global information from the basic division, the basic division can be adjusted by minimizing ∥Hᵢ−SHᵢ∥_{F}², where S is a graph matrix shared by all basis kernels, satisfying S≥0, S1=1, and elements on a diagonal are 0.

The “constructing an objective function by combining kernel k-means clustering and graph improvement methods” is expressed as:

$${min}_{S , {\{ {H}_{i} \}}_{i = 1}^{m}} {\sum }_{i = 1}^{m} T r ( {K}_{i} ( {I}_{n} - {H}_{i} {H}_{i}^{T} ) ) + λ {‖ {H}_{i} - S {H}_{i} ‖}_{F}^{2} + β {‖ S ‖}_{F}^{2} \qquad ( 4 )$$

$$s . t . S \geq 0 , S 1 = 1 , diag ( S ) = 0 , {H}_{i}^{T} {H}_{i} = {I}_{k} \qquad ( 5 )$$

where Hᵢ represents a basic division matrix obtained from a i^{th} running kernel k-means clustering; λ and β represent hyperparameters that adjust a proportion of each item; Hᵢ^{T} represents a transpose of Hᵢ; S represents a proxy graph matrix; and Iₙ represents the n-dimensional identity matrix.

Since Equation (4) can make use of S for adjusting the Hᵢ, the algorithm is named “later-fusion multiple kernel clustering based on proxy graph improvement”.

In the step S4, the objective function constructed in the step S3 is cyclically solved so as to obtain a graph matrix, which is fused with basic kernel information.

The objective function can be solved using the following two-step iterative method, specifically:
S41. fixing S and optimizing {Hᵢ}ᵢ₌₁^{m}, each Hᵢ can be optimized individually, which is expressed as:

$${min}_{{H}_{i}} T r ( {K}_{i} ( {I}_{n} - {H}_{i} {H}_{i}^{T} ) ) + λ {‖ {H}_{i} - S {H}_{i} ‖}_{F}^{2} , s . t . {H}_{i}^{T} {H}_{i} = {I}_{k} \qquad ( 6 )$$

assuming G=Kᵢ−λ(Iₙ−2S+SS^{T}), then Equation (6) is expressed as:

$$T r ( G {H}_{i} {H}_{i}^{T} ) , s . t . {H}_{i}^{T} {H}_{i} = {I}_{k} \qquad ( 7 )$$

performing eigendecomposition on G, assuming that Hᵢ represents an eigenvector corresponding to its first k largest eigenvalues, and then obtaining the optimal solution;
S42. fixing {Hᵢ}ᵢ₌₁^{m} and optimizing S, the optimization problem can be then transformed into the following Equation, being expressed as:

$${min}_{S} {\sum }_{i = 1}^{m} λ {‖ {H}_{i} - S {H}_{i} ‖}_{F}^{2} + β {‖ S ‖}_{F}^{2} , s . t . S \geq 0 , S 1 = 1 , diag ( S ) = 0 \qquad ( 8 )$$

Equation (8) is solved through the steps S421 and S422:
S421. solving an unconstrained solution of Equation (8), being expressed as:

$$\hat{S} = {arg min}_{S} {\sum }_{i = 1}^{m} λ {‖ {H}_{i} - S {H}_{i} ‖}_{F}^{2} + β {‖ S ‖}_{F}^{2} \qquad ( 9 )$$

Using a derivative 0 to obtain a closed-form solution

$$\hat{S} = {( C + ( \frac{β}{λ} ) I )}^{- 1} C , where C = {Σ}_{i = 1}^{m} {H}_{i} {H}_{i}^{T} ;$$

S422. calculating a solution closest to Ŝ that satisfies constraints through Equation (10):

$${min}_{S} {‖ S - \hat{S} ‖}_{F}^{2} , s . t . S \geq 0 , S 1 = 1 , diag ( S ) = 0 \qquad ( 10 )$$

where Ŝ represents a solution of the proxy graph matrix when being unconstrained.

Obtaining a closed-form solution:

$${S}_{j , :} = max ( {\hat{S}}_{j , :} + {α}_{j} 1 , 0 ) , {S}_{jj} = 0 , {α}_{j} = \frac{1 + {\hat{S}}_{j , :}^{T} 1}{n} \qquad ( 11 )$$

where S_{j,:} represents a j^{th} column of a matrix S, αⱼ represents an intermediate variable used for solution; Ŝ_{j,:} represents a j^{th} column of Ŝ; and Ŝ_{j,:}^{T} represents a transpose of Ŝ_{j,:}.

A termination condition of the above two-step (the steps S41 and S42) alternating method is expressed as:

$$\frac{{obj}^{( t - 1 )} - {obj}^{( t )}}{{obj}^{( t )}} \leq ε \qquad ( 12 )$$

where obj^{(t-1)} and obj^{(t)} represent values of the objective function at t^{th} and t−1^{th} iterations, respectively; and E represents a set precision.

In the step S5, spectral clustering is performed on the obtained graph matrix, so as to obtain a final clustering result.

A standard spectral clustering algorithm is performed on the outputted graph matrix S to obtain the final clustering result.

This embodiment provides a novel later-fusion multiple kernel clustering machine learning method based on proxy graph improvement, and the method includes a basic division acquisition module, a proxy graph construction module, a basic division improvement module through the proxy graph, a spectral clustering module through the proxy graph, and the like. By optimizing the basic division, an optimized basic division not only has information of a single kernel, but can also obtain global information by means of a proxy graph, which is more beneficial to fusing views, such that a learned proxy graph can better fuse information of each kernel matrix, thereby realizing an aim of improving a clustering effect.

### Embodiment 2

A later-fusion multiple kernel clustering machine learning method based on proxy graph improvement provided in this embodiment is distinguished from that in Embodiment 1 by:

In this embodiment, the clustering performance of the method of the present disclosure is tested on six MKL standard data sets.

The six MKL standard data sets are AR10P, YALE, Protein fold prediction, Oxford Flower17, Nonplant and Oxford Flower102. Information of the data sets is illustrated in Table 1.

TABLE 1

| Dataset | Samples | Kernels | Clusters |
|---|---|---|---|
| AR10P | 130 | 6 | 10 |
| YALE | 165 | 5 | 15 |
| ProteinFold | 694 | 12 | 27 |
| Flower17 | 1360 | 7 | 17 |
| Nonplant | 2372 | 69 | 3 |
| Flower102 | 8189 | 4 | 102 |

For ProteinFold, this embodiment generates 12 benchmark kernel matrices, in which the first 10 feature sets adopt second-order polynomial kernels, and the last two adopt cosine inner product kernels. Kernel matrices of other data sets can be publicly downloaded from the Internet.

This embodiment adopts such algorithms as a best single-view kernel k-means clustering (BSKM), a multiple kernel k-means clustering (MKKM), a co-regularized spectral clustering (CRSC), a robust multiple kernel k-means clustering (RMKKM), a robust multi-view spectral clustering (RMSC), a multiple kernel k-means with matrix-induced regularization (MKMR), a multiple kernel clustering with local kernel alignment maximization (MKAM), a multi-view clustering via later fusion alignment maximization (MLFA) and a flexible multi-view representation learning for subspace clustering (FMR). In all experiments, all basis kernels are first centered and regularized. For all datasets, the number of classes is assumed to be known and set to be the number of cluster classes. Parameters of the compared algorithms adopted in this experiment are all set according to the corresponding literature. Parameters λ and β of the method are chosen from [2⁻², 2⁻¹, . . . , 2²] through grid search.

The embodiment adopts widely used clustering accuracy (ACC), normalized mutual information (NMI) and purity to evaluate the clustering performance of each algorithm. For all algorithms, each experiment is repeated for 50 times with random initialization, and the best result is reported to reduce the effect of randomness caused by k-means.

TABLE 2

| | | | | | | | | | | |
|---|---|---|---|---|---|---|---|---|---|---|
| Dataset | BSKM | MKKM | CRSC | RMKKM | RMSC | MKMR | MKAM | MLFA | FMR | Proposed |

ACC (%)

| | | | | | | | | | | |
|---|---|---|---|---|---|---|---|---|---|---|
| AR10P | 43.08 | 40.00 | 38.46 | 30.77 | 30.77 | 39.23 | 27.69 | 41.54 | 51.23 | 56.15 |
| YALE | 56.97 | 52.12 | 56.97 | 56.36 | 58.03 | 60.00 | 46.67 | 54.55 | 61.21 | 62.42 |
| ProteinFold | 33.86 | 27.23 | 34.87 | 30.98 | 33.00 | 36.46 | 37.90 | 35.88 | 34.96 | 40.06 |
| Flower17 | 42.06 | 45.37 | 52.35 | 53.38 | 51.10 | 58.82 | 57.87 | 60.16 | 58.78 | 62.28 |
| Nonplant | 49.38 | 54.32 | 55.56 | 49.33 | 60.65 | 56.59 | 59.57 | 50.07 | 36.70 | 67.50 |
| Flower102 | 33.13 | 21.96 | 37.26 | 28.17 | 32.97 | 39.91 | 40.84 | 42.73 | 35.24 | 46.78 |

NMI (%)

| | | | | | | | | | | |
|---|---|---|---|---|---|---|---|---|---|---|
| AR10P | 42.61 | 39.53 | 39.82 | 26.62 | 27.87 | 40.11 | 24.72 | 39.15 | 45.52 | 51.82 |
| YALE | 58.42 | 54.16 | 57.69 | 59.32 | 57.58 | 62.87 | 53.51 | 59.86 | 60.31 | 63.48 |
| ProteinFold | 42.03 | 37.16 | 43.32 | 38.78 | 43.91 | 45.32 | 44.46 | 44.00 | 43.68 | 48.72 |
| Flower17 | 45.14 | 45.35 | 50.42 | 52.56 | 54.39 | 57.05 | 56.06 | 59.79 | 56.98 | 61.72 |
| Nonplant | 16.55 | 15.83 | 17.44 | 16.55 | 20.35 | 23.43 | 23.04 | 16.55 | 0.50 | 25.56 |
| Flower102 | 48.99 | 42.30 | 54.18 | 48.17 | 53.36 | 57.27 | 57.60 | 57.59 | 57.42 | 60.30 |

Purity(%)

| | | | | | | | | | | |
|---|---|---|---|---|---|---|---|---|---|---|
| AR10P | 43.08 | 40.00 | 39.23 | 32.31 | 33.08 | 39.23 | 28.46 | 41.54 | 51.23 | 56.15 |
| YALE | 57.58 | 52.73 | 57.58 | 58.18 | 57.24 | 60.00 | 49.09 | 55.76 | 61.33 | 62.42 |
| ProteinFold | 41.21 | 33.86 | 40.78 | 36.60 | 42.36 | 42.65 | 43.95 | 41.93 | 42.22 | 45.97 |
| Flower17 | 44.63 | 46.84 | 53.01 | 55.07 | 54.12 | 60.51 | 59.26 | 62.13 | 59.66 | 63.60 |
| Nonplant | 72.18 | 71.45 | 73.17 | 72.18 | 70.50 | 73.33 | 74.34 | 72.18 | 60.36 | 75.29 |
| Flower102 | 38.78 | 27.61 | 44.08 | 33.86 | 40.24 | 46.39 | 48.21 | 49.73 | 41.62 | 53.07 |

Table 2 shows clustering effects of the above method and the compared algorithms on the six data sets of different algorithms. It can be concluded from the above table that: 1. the proposed algorithm is superior to all compared algorithms under the three evaluation criteria; and 2. the proposed algorithm outperforms the second-best compared algorithm by 4.92%, 1.21%, 2.16%, 2.12%, 6.85% and 4.05% on ACC of the six data sets, respectively.

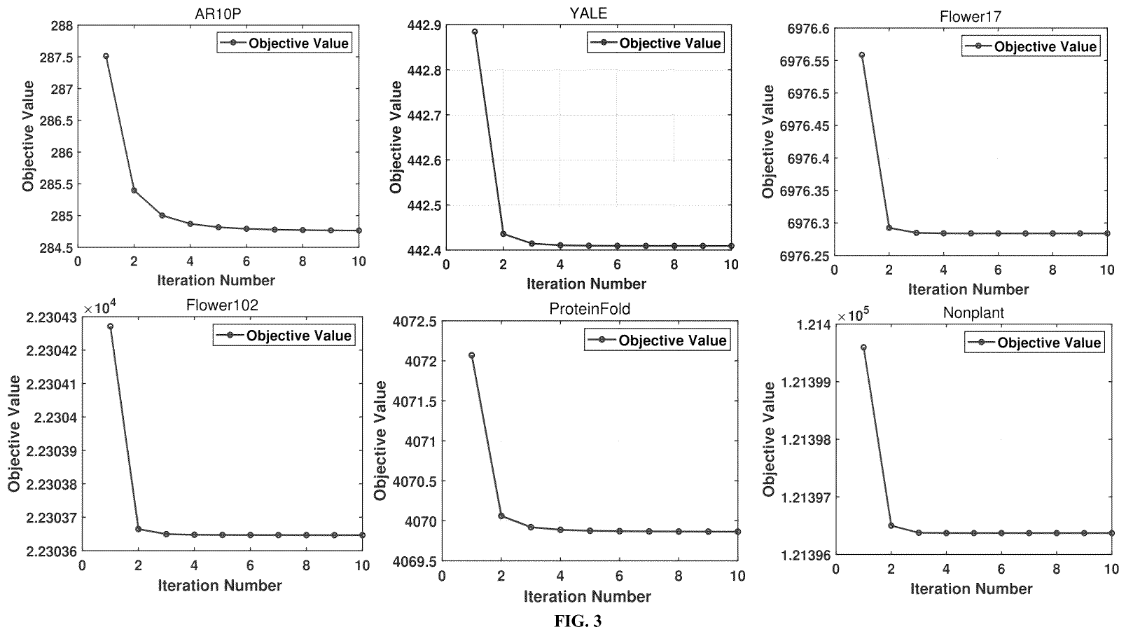

This embodiment also presents changes in the objective function of each iteration, as shown in FIG. 3. It can be seen that values of the objective function decreases monotonously and usually converge within 10 iterations, which can greatly reduce the running time of the algorithm.

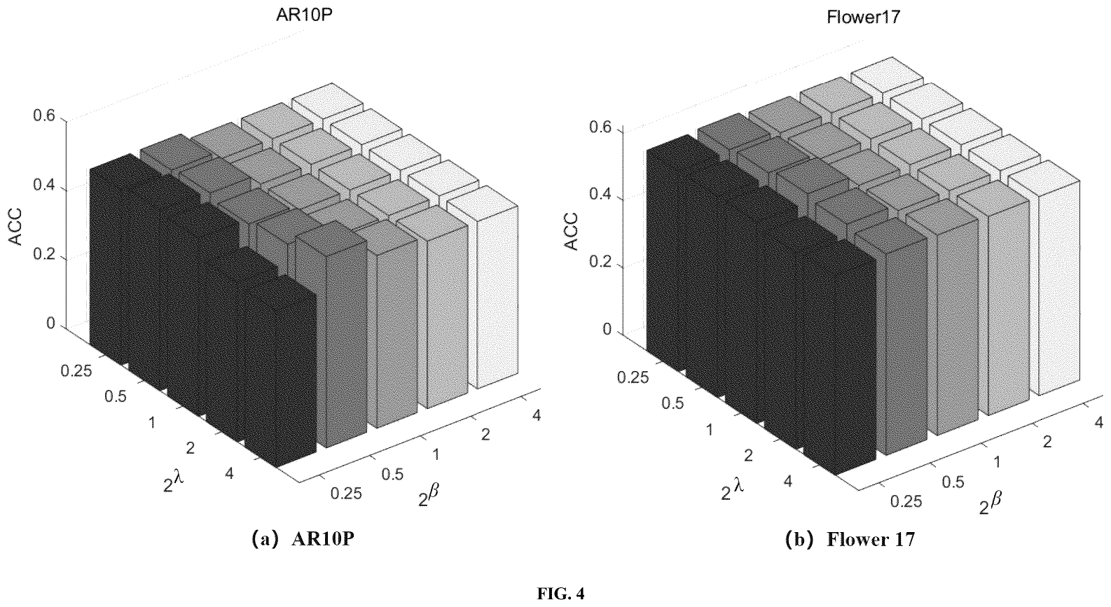

FIG. 4 shows the parameter sensitivity, taking two data sets such as AR10P and Flower17 as examples. It can be seen from the figure that the proposed algorithm is relatively stable for both hyperparameters and can achieve good performance in a wide range.

The experimental results of this embodiment on six multi-kernel data sets prove that the performance of the present disclosure is better than those of existing methods.

### Embodiment 3

This embodiment provides a later-fusion multiple kernel clustering machine learning system based on proxy graph improvement, including:
an acquisition module for acquiring a clustering task and a target data sample;
an initialization module for initializing a proxy graph improvement matrix;
a construction module for running k-means clustering and graph improvement on each view corresponding to the acquisition of the clustering task and the target data sample, and constructing an objective function by combining kernel k-means clustering and graph improvement methods;
a solution module for cyclically solving the constructed objective function, so as to obtain a graph matrix, which is fused with basic kernel information; and
a clustering module for performing spectral clustering on the obtained graph matrix, so as to obtain a final clustering result.

Further, the objective function of kernel k-means clustering in the construction module is expressed as:

$${min}_{B ∈ {\{ 0 , 1 \}}^{n \times k}} {\sum }_{i = 1 , c = 1}^{n , k} {B}_{i c} {‖ ϕ ( {x}_{i} ) - {μ}_{c} ‖}_{2}^{2} s . t . {\sum }_{c = 1}^{k} {B}_{i c} = 1 \qquad ( 1 )$$

where {xᵢ}ᵢ₌₁ⁿ⊆ [symbol] represents a data set consisting of n samples; B∈{0,1}^{n×k} represents a clustering indicator matrix, when an i^{th} sample belongs to a c^{th} cluster, B_{ic}=1, otherwise, B_{ic}=0; ϕ:x∈ [symbol] → [symbol] represent feature mapping that a sample x is projected to a reproducing kernel Hilbert space [symbol] ; μ_{c}=(1/n_{c})Σᵢ₌₁ⁿB_{ic}ϕ(xᵢ), where n_{c} represents the number of samples belonging to the c^{th} cluster, xᵢ represents a data sample; i represents a sample serial number; n represents the number of sample points; and k represents a total number of clusters.

Assuming <ϕ(xᵢ),ϕ(xⱼ)>=Kᵢⱼ, where Kᵢⱼ represents elements of a kernel matrix K, then Equation (1) is expressed as:

$${min}_{B ∈ {\{ 0 , 1 \}}^{n \times k}} T r ( K ) - Tr ( {L}^{\frac{1}{2}} {B}^{T} K B {L}^{\frac{1}{2}} ) s . t . B {1}_{k} = {1}_{n} \qquad ( 2 )$$

where K represents the kernel matrix, L=diag([n₁⁻¹, . . . , nₖ⁻¹]), nₖ⁻¹ represents a reciprocal of a total number of samples belonging to a k^{th} cluster, 1ₖ∈R^{k} represents a vector with all elements being 1; and B^{T} represents a transpose of B.
assuming

$$H = B {L}^{\frac{1}{2}} and {H}^{T} H = {I}_{k} ,$$

then Equation (2) is expressed as:

$${min}_{{H}^{T} H = {I}_{k}} T r ( K ( {I}_{n} - H {H}^{T} ) ) \qquad ( 3 )$$

where H^{T} represents a transpose of H, Iₙ represents an n-dimensional identity matrix, and Iₖ represents a k-dimensional identity matrix.

Further, the objective function constructed in the construction module is expressed as:

$${min}_{S , {\{ {H}_{i} \}}_{i = 1}^{m}} {\sum }_{i = 1}^{m} T r ( {K}_{i} ( {I}_{n} - {H}_{i} {H}_{i}^{T} ) ) + λ {‖ {H}_{i} - S {H}_{i} ‖}_{F}^{2} + β {‖ S ‖}_{F}^{2} \qquad ( 4 )$$

$$s . t . S \geq 0 , S 1 = 1 , diag ( S ) = 0 , {H}_{i}^{T} {H}_{i} = {I}_{k} \qquad ( 5 )$$

where Hᵢ represents a basic division matrix obtained from an i^{th} running kernel k-means clustering; λ and β represent hyperparameters that adjust a proportion of each item; Hᵢ^{T} represents a transpose of Hᵢ; S represents a proxy graph matrix; and Iₙ represents the n-dimensional identity matrix.

Further, the constructed objective function is cyclically solved in the solution module, specifically:
a first fixed module is used for fixing S and optimizing {Hᵢ}ᵢ₌₁^{m}, being expressed as:

$${min}_{{H}_{i}} T r ( {K}_{i} ( {I}_{n} - {H}_{i} {H}_{i}^{T} ) ) + λ {‖ {H}_{i} - S {H}_{i} ‖}_{F}^{2} , s . t . {H}_{i}^{T} {H}_{i} = {I}_{k} \qquad ( 6 )$$

assuming G=Kᵢ−λ(Iₙ−2S+SS^{T}), then Equation (6) is expressed as:

$$T r ( G {H}_{i} {H}_{i}^{T} ) , s . t . {H}_{i}^{T} {H}_{i} = {I}_{k} \qquad ( 7 )$$

performing eigendecomposition on G, assuming that Hᵢ represents an eigenvector corresponding to its first k largest eigenvalues, and then obtaining the optimal solution;
a second fixed module is used for fixing {Hᵢ}ᵢ₌₁^{m} and optimizing S, being expressed as:

$${min}_{S} {\sum }_{i = 1}^{m} λ {‖ {H}_{i} - S {H}_{i} ‖}_{F}^{2} + β {‖ S ‖}_{F}^{2} , s . t . S \geq 0 , S 1 = 1 , diag ( S ) = 0 \qquad ( 8 )$$

Solving Equation (8):
solving an unconstrained solution of Equation (8), being expressed as:

$$\hat{S} = {argmin}_{S} {\sum }_{i = 1}^{m} λ ‖ {H}_{i} - {SH}_{i} {‖}_{F}^{2} + β ‖ S {‖}_{F}^{2} \qquad ( 9 )$$

Using a derivative 0 to obtain a closed-form solution

$$\hat{S} = {( C + ( \frac{β}{λ} ) I )}^{- 1} C , where C = {\sum }_{i = 1}^{m} {H}_{i} {H}_{i}^{T} ;$$

calculating a solution closest to Ŝ that satisfies constraints:

$${min}_{S} {‖ S - \hat{S} ‖}_{F}^{2} , s . t . S \geq 0 , S 1 = 1 , diag ( S ) = 0 \qquad ( 10 )$$

where Ŝ represents a solution of the proxy graph matrix when being unconstrained.

Obtaining a closed-form solution:

$${S}_{j , :} = max ( {\hat{S}}_{j , :} + {α}_{j} 1 , 0 ) , {S}_{jj} = 0 , {α}_{j} = \frac{1 + {\hat{S}}_{j , :}^{T} 1}{n} \qquad ( 11 )$$

where S_{j,:} represents a j^{th} column of a matrix S, αⱼ represents an intermediate variable used for solution; Ŝ_{j,:} represents a j^{th} column of Ŝ; and Ŝ_{j,:}^{T} represents a transpose of Ŝ_{j,:}.

Further, the constructed objective function is cyclically solved, with a cycle termination condition being expressed as:

$$\frac{{obj}^{( t - 1 )} - {obj}^{( t )}}{{obj}^{( t )}} \leq ε \qquad ( 12 )$$

where obj^{(t-1)} and obj^{(t)} represent values of the objective function at t^{th} and t−1^{th} iterations, respectively; and E represents a set precision.

It should be noted that the later-fusion multiple kernel clustering machine learning system based on proxy graph improvement provided in this embodiment is similar to that in Embodiment 1, and will not be described in detail here.

The system provided in the present disclosure includes a basic division acquisition module, a proxy graph construction module, a basic division improvement module through the proxy graph, a spectral clustering module through the proxy graph, and the like. By optimizing the basic division, an optimized basic division not only has information of a single kernel, but can also obtain global information by means of a proxy graph, which is more beneficial to fusing views, such that a learned proxy graph can better fuse information of each kernel matrix, thereby realizing an aim of improving a clustering effect.

It should be noted that what is described above is merely illustrative of the preferred embodiments of the present disclosure and the technical principles applied. Those skilled in the art will understand that the present disclosure is not limited to the particular embodiments described herein, and various obvious changes, readjustments and substitutions may be made by those skilled in the art without departing from the scope of protection of the present disclosure. Therefore, although the present disclosure has been described in greater detail by way of the above embodiments, the present disclosure is not limited to the above embodiments and may include many other equivalent embodiments without departing from the concept of the present disclosure, the scope of the present disclosure is determined by the scope of the appended claims.

What is claimed is:

1. A later-fusion multiple kernel clustering machine learning method based on proxy graph improvement, comprising the following steps:
S1: acquiring a clustering task and a target data sample;
S2: initializing a proxy graph improvement matrix;
S3: running k-means clustering and graph improvement on each view corresponding to the acquisition of the clustering task and the target data sample, and constructing an objective function by combining kernel k-means clustering and graph improvement methods;
S4: cyclically solving the objective function constructed in the step S3 to obtain a graph matrix fused with basic kernel information; and
S5: performing spectral clustering on the graph matrix to obtain a final clustering result.

2. The later-fusion multiple kernel clustering machine learning method based on proxy graph improvement according to claim 1, wherein the objective function of kernel k-means clustering constructed in the step S3 is expressed as:
$${min}_{B ∈ {\{ 0 , 1 \}}^{n \times k}} {\sum }_{i = 1 , c = 1}^{n , k} {B}_{ic} {‖ ϕ ( {x}_{i} ) - {μ}_{c} ‖}_{2}^{2} s . t . {\sum }_{c = 1}^{k} {B}_{ic} = 1 \qquad ( 1 )$$
wherein {xᵢ}ᵢ₌₁ⁿ⊆ [symbol] represents a data set consisting of n samples; B∈{0,1}^{n×k} represents a clustering indicator matrix, when the i^{th} sample belongs to the c^{th} cluster, B_{ic}=1, otherwise, B_{ic}=0; ϕ:x∈ [symbol] → [symbol] represent feature mapping that a sample x is projected to a reproducing kernel Hilbert space [symbol] ; μ_{c}=(1/n_{c})Σᵢ₌₁ⁿB_{ic}ϕ(xᵢ), where n_{c} represents the number of samples belonging to the c^{th} cluster, xᵢ represents a data sample; i represents a sample serial number; n represents the number of sample points; and k represents the total number of clusters;
assuming <ϕ(xᵢ),ϕ(xⱼ)>=Kᵢⱼ, where Kᵢⱼ represents elements of a kernel matrix K, then Equation (1) is expressed as:
$${min}_{B ∈ {\{ 0 , 1 \}}^{n \times k}} Tr ( K ) - Tr ( {L}^{\frac{1}{2}} {B}^{T} {KBL}^{\frac{1}{2}} ) s . t . B {1}_{k} = {1}_{n} \qquad ( 2 )$$
where K represents the kernel matrix, L=diag([n₁⁻¹, . . . , nₖ⁻¹]), nₖ⁻¹ represents a reciprocal of the total number of samples belonging to the k^{th} cluster, 1ₖ∈R^{k} represents a vector with all elements being 1; and B^{T} represents a transpose of B; and
assuming H=BL1/2 and H^{T}H=Iₖ, then Equation (2) is expressed as:
$${min}_{{H}^{T} H = {I}_{k}} Tr ( K ( {I}_{n} - {HH}^{T} ) ) \qquad ( 3 )$$
wherein H^{T} represents a transpose of H, Iₙ represents an n-dimensional identity matrix, and Iₖ represents a k-dimensional identity matrix.

3. The later-fusion multiple kernel clustering machine learning method based on proxy graph improvement according to claim 2, wherein the objective function constructed in the step S3 is expressed as:
$${min}_{S , {\{ {H}_{i} \}}_{i = 1}^{m}} {\sum }_{i = 1}^{m} Tr ( {K}_{i} ( {I}_{n} - {H}_{i} {H}_{i}^{T} ) ) + λ ‖ {H}_{i} - {SH}_{i} {‖}_{F}^{2} + β ‖ S {‖}_{F}^{2} \qquad ( 4 )$$
$$s . t . S \geq 0 , S 1 = 1 , diag ( S ) = 0 , {H}_{i}^{T} {H}_{i} = {I}_{k} \qquad ( 5 )$$
wherein Hᵢ represents a basic division matrix obtained from the i^{th} running kernel k-means clustering; λ and β represent hyperparameters for adjusting a proportion of each item; Hᵢ^{T} represents a transpose of Hᵢ; S represents a proxy graph matrix; and Iₙ represents the n-dimensional identity matrix.

4. The later-fusion multiple kernel clustering machine learning method based on proxy graph improvement according to claim 3, wherein the objective function constructed in the step S3 is cyclically solved in the step S4 as follow:
S41: fixing S and optimizing {Hᵢ}ᵢ₌₁^{m}, being expressed as:
$${min}_{{H}_{i}} Tr ( {K}_{i} ( {I}_{n} - {H}_{i} {H}_{i}^{T} ) ) + λ ‖ {H}_{i} - {SH}_{i} {‖}_{F}^{2} , s . t . {H}_{i}^{T} {H}_{i} = {I}_{k} \qquad ( 6 )$$
assuming G=Kᵢ−λ(Iₙ−2S+SS^{T}), then Equation (6) is expressed as:
$$Tr ( {GH}_{i} {H}_{i}^{T} ) , s . t . {H}_{i}^{T} {H}_{i} = {I}_{k} \qquad ( 7 )$$
performing eigendecomposition on G, assuming that Hᵢ represents an eigenvector corresponding to the first k largest eigenvalues of G, and then obtaining the optimal solution; and
S42: fixing {Hᵢ}ᵢ₌₁^{m} and optimizing S, being expressed as:
$${min}_{s} {\sum }_{i = 1}^{m} λ ‖ {H}_{i} - {SH}_{i} {‖}_{F}^{2} + β ‖ S {‖}_{F}^{2} , s . t . S \geq 0 , S 1 = 1 , diag ( S ) = 0 \qquad ( 8 )$$
Equation (8) is solved through the steps S421 and S422:
S421: solving an unconstrained solution of Equation (8), being expressed as:
$$\hat{S} = {argmin}_{S} {\sum }_{i = 1}^{m} λ ‖ {H}_{i} - {SH}_{i} {‖}_{F}^{2} + β ‖ S {‖}_{F}^{2} \qquad ( 9 )$$
using a derivative 0 to obtain a closed-form solution
$$\hat{S} = {( C + ( \frac{β}{λ} ) I )}^{- 1} C , wherein C = {\sum }_{i = 1}^{m} {H}_{i} {H}_{i}^{T} ;$$
and
S422; calculating a solution closest to Ŝ that satisfies constraints through Equation (10):
$${min}_{S} {‖ S - \hat{S} ‖}_{F}^{2} , s . t . S \geq 0 , S 1 = 1 , diag ( S ) = 0 \qquad ( 10 )$$
wherein Ŝ represents the solution of a proxy graph matrix when being unconstrained; and
obtaining a closed-form solution:
$${S}_{j , :} = max ( {\hat{S}}_{j , :} + {α}_{j} 1 , 0 ) , {S}_{jj} = 0 , {α}_{j} = \frac{1 + {\hat{S}}_{j , :}^{T} 1}{n} \qquad ( 11 )$$
wherein S_{j,:} represents the j^{th} column of a matrix S, αⱼ represents an intermediate variable used for solution; Ŝ_{j,:} represents the j^{th} column of Ŝ; and Ŝ_{j,:}^{T} represents a transpose of Ŝ_{j,:}.

5. The later-fusion multiple kernel clustering machine learning method based on proxy graph improvement according to claim 4, wherein the objective function constructed in the step S3 is cyclically solved, with a cycle termination condition being expressed as:
$$\frac{{obj}^{( t - 1 )} - {obj}^{( t )}}{{obj}^{( t )}} \leq ε \qquad ( 12 )$$
wherein obj^{(t-1)} and obj^{(t)} represent values of the objective function at t^{th} and t−1^{th} iterations, respectively; and ε represents a set precision.

6. A later-fusion multiple kernel clustering machine learning system based on proxy graph improvement, comprising:
an acquisition module for acquiring a clustering task and a target data sample;
an initialization module for initializing a proxy graph improvement matrix;
a construction module for running k-means clustering and graph improvement on each view corresponding to the acquisition of the clustering task and the target data sample, and constructing an objective function by combining kernel k-means clustering and graph improvement methods;
a solution module for cyclically solving the objective function to obtain a graph matrix fused with basic kernel information; and
a clustering module for performing spectral clustering on the graph matrix to obtain a final clustering result.

7. The later-fusion multiple kernel clustering machine learning system based on proxy graph improvement according to claim 6, wherein the objective function of kernel k-means clustering in the construction module is expressed as:
$${min}_{B ∈ {\{ 0 , 1 \}}^{n \times k}} {\sum }_{i = 1 , c = 1}^{n , k} {B}_{ic} {‖ ϕ ( {x}_{i} ) - {μ}_{c} ‖}_{2}^{2} s . t . {\sum }_{c = 1}^{k} {B}_{ic} = 1 \qquad ( 1 )$$
wherein {xᵢ}ᵢ₌₁ⁿ⊆ [symbol] represents a data set consisting of n samples; B∈{0,1}^{n×k} represents a clustering indicator matrix, when the i^{th} sample belongs to the c^{th} cluster, B_{ic}=1, otherwise, B_{ic}=0; ϕ:x∈ [symbol] → [symbol] represent feature mapping that a sample x is projected to a reproducing kernel Hilbert space [symbol] ; μ_{c}=(1/n_{c})Σᵢ₌₁ⁿB_{ic}ϕ(xᵢ), where n_{c} represents the number of samples belonging to the c^{th} cluster, xᵢ represents a data sample; i represents a sample serial number; n represents the number of sample points; and k represents the total number of clusters;
assuming <ϕ(xᵢ),ϕ(xⱼ)>=Kᵢⱼ, where Kᵢⱼ represents elements of a kernel matrix K, then Equation (1) is expressed as:
$${min}_{B ∈ {\{ 0 , 1 \}}^{n \times k}} Tr ( K ) - Tr ( {L}^{\frac{1}{2}} {B}^{T} {KBL}^{\frac{1}{2}} ) s . t . B {1}_{k} = {1}_{n} \qquad ( 2 )$$
where K represents the kernel matrix, L=diag([n₁⁻¹, . . . , nₖ⁻¹]), nₖ⁻¹ represents a reciprocal of the total number of samples belonging to the k^{th} cluster, 1ₖ∈R^{k} represents a vector with all elements being 1; and B^{T} represents a transpose of B; and
assuming
$$H = {BL}^{\frac{1}{2}} and {H}^{T} H = {I}_{k} ,$$
then Equation (2) is expressed as:
$${min}_{{H}^{T} H = {I}_{k}} Tr ( K ( {I}_{n} - {HH}^{T} ) ) \qquad ( 3 )$$
wherein H^{T} represents a transpose of H, Iₙ represents an n-dimensional identity matrix, and Iₖ represents a k-dimensional identity matrix.

8. The later-fusion multiple kernel clustering machine learning system based on proxy graph improvement according to claim 7, wherein the objective function constructed in the construction module is expressed as:
$${min}_{S , {\{ {H}_{i} \}}_{i = 1}^{m}} {\sum }_{i = 1}^{m} Tr ( {K}_{i} ( {I}_{n} - {H}_{i} {H}_{i}^{T} ) ) + λ {‖ {H}_{i} - {SH}_{i} ‖}_{F}^{2} + β {‖ S ‖}_{F}^{2} \qquad ( 4 )$$
$$s . t . S \geq 0 , S 1 = 1 , diag ( S ) = 0 , {H}_{i}^{T} {H}_{i} = {I}_{k} \qquad ( 5 )$$
wherein Hᵢ represents a basic division matrix obtained from the i^{th} running kernel k-means clustering; λ and β represent hyperparameters for adjusting a proportion of each item; Hᵢ^{T} represents a transpose of Hᵢ; S represents a proxy graph matrix; and Iₙ represents the n-dimensional identity matrix.

9. The later-fusion multiple kernel clustering machine learning system based on proxy graph improvement according to claim 8, wherein the objective function is cyclically solved in the solution module as follow:
a first fixed module is used for fixing S and optimizing {Hᵢ}ᵢ₌₁^{m}, being expressed as:
$${min}_{{H}_{i}} Tr ( {K}_{i} ( {I}_{n} - {H}_{i} {H}_{i}^{T} ) ) + λ {‖ {H}_{i} - {SH}_{i} ‖}_{F}^{2} , s . t . {H}_{i}^{T} {H}_{i} = {I}_{k} \qquad ( 6 )$$
assuming G=Kᵢ−λ(Iₙ−2S+SS^{T}), then Equation (6) is expressed as:
$$Tr ( {GH}_{i} {H}_{i}^{T} ) , s . t . {H}_{i}^{T} {H}_{i} = {I}_{k} \qquad ( 7 )$$
performing eigendecomposition on G, assuming that Hᵢ represents an eigenvector corresponding to the first k largest eigenvalues of G, and then obtaining the optimal solution; and
a second fixed module is used for fixing {Hᵢ}ᵢ₌₁^{m} and optimizing S, being expressed as:
$${min}_{S} {\sum }_{i = 1}^{m} λ {‖ {H}_{i} - {SH}_{i} ‖}_{F}^{2} + β {‖ S ‖}_{F}^{2} , s . t . S \geq 0 , S 1 = 1 , diag ( S ) = 0 \qquad ( 8 )$$
solving Equation (8):
solving an unconstrained solution of Equation (8), being expressed as:
$$\hat{S} = {arg min}_{S} {\sum }_{i = 1}^{m} λ {‖ {H}_{i} - {SH}_{i} ‖}_{F}^{2} + β {‖ S ‖}_{F}^{2} \qquad ( 9 )$$
using a derivative 0 to obtain a closed-form solution
$$\hat{S} = {( C + ( \frac{β}{λ} ) I )}^{- 1} C , wherein C = {\sum }_{i = 1}^{m} {H}_{i} {H}_{i}^{T} ;$$
calculating a solution closest to Ŝ that satisfies constraints:
$${min}_{S} {‖ S - \hat{S} ‖}_{F}^{2} , s . t . S \geq 0 , S 1 = 1 , diag ( S ) = 0 \qquad ( 10 )$$
wherein Ŝ represents the solution of a proxy graph matrix when being unconstrained; and
obtaining a closed-form solution:
$${S}_{j , :} = max ( {\hat{S}}_{j , :} + {α}_{j} 1 , 0 ) , {S}_{jj} = 0 , {α}_{j} = \frac{1 + {\hat{S}}_{j , :}^{T} 1}{n} \qquad ( 11 )$$
wherein S_{j,:} represents the j^{th} column of a matrix S, αⱼ represents an intermediate variable used for solution; Ŝ_{j,:} represents the j^{th} column of Ŝ; and Ŝ_{j,:}^{T} represents a transpose of Ŝ_{j,:}.

10. The later-fusion multiple kernel clustering machine learning system based on proxy graph improvement according to claim 9, wherein the objective function is cyclically solved, with a cycle termination condition being expressed as:
$$\frac{{obj}^{( t - 1 )} - {obj}^{( t )}}{{obj}^{( t )}} \leq ε \qquad ( 12 )$$
wherein obj^{(t-1)} and obj^{(t)} represent values of the objective function at t^{th} and t−1^{th} iterations, respectively; and ε represents a set precision.
